(19) United States
(12) Patent Application Publication
(10) Pub. No.: US 2014/0182392 A1
(43) Pub. Date: Jul. 3, 2014

(54) APPARATUS AND METHOD FOR BREAKAGE TESTING OF SMALL ARTICLES

(71) Applicant: APPLE INC., Cupertino, CA (US)

(72) Inventors: Charles B. Woodhull, Cupertino, CA (US); David A. Pakula, San Francisco, CA (US); Vignesh Danabalan, San Jose, CA (US)

(73) Assignee: APPLE INC., Cupertino, CA (US)

(21) Appl. No.: 13/733,043

(22) Filed: Jan. 2, 2013

(51) Int. Cl. G01N 3/20; B24B 1/00

(52) U.S. Cl. CPC G01N 3/20; B24B 1/00
USPC 73/851; 451/51

(57) ABSTRACT

Apparatus, systems and methods for testing brittle articles, such as glass or ceramic articles are disclosed. The testing is provided by a test apparatus that imposes a bending test to a brittle article. The testing is also well suited for testing small scale brittle articles which are too small to utilize conventional multi-point testing or ring-on-ring testing. In addition, the testing is also well suited for testing brittle articles that have one or more apertures (or holes) therein which can impact their ability to resist breakage. For example, the quality of one or more apertures provided in brittle articles can affect breakage levels and thus can be monitored and/or adjusted through testing.

### BACKGROUND OF THE INVENTION

Glass surfaces have become increasingly popular for use in consumer electronic products, such as handheld electronic devices. Such devices often use glass surfaces, which can be used as protective outer surfaces for such devices. Although plastic may be used instead of glass, glass tends to provide a better protective barrier given its strength and scratch resistance. However, since glass is rather brittle, efforts (such as chemical strengthening) are often taken to improve strength of the glass. For quality control purposes, outer glass surfaces can be tested for breakage. Conventional tests, such as multi-point testing or ring-on-ring testing, can be used. Unfortunately, however, with smaller scale glass articles, these conventional tests are not able to provide adequate testing. Thus, there is a continuing need for improved approaches for testing glass articles, particularly smaller scale glass articles.

### SUMMARY

The invention relates generally to testing brittle articles, such as glass or ceramic articles. The testing is provided by a test apparatus that imposes a bending test to a brittle article. The testing is also well suited for testing small scale brittle articles which are too small to utilize conventional multi-point testing or ring-on-ring testing. In addition, the testing is also well suited for testing brittle articles that have one or more apertures (or holes) therein which can impact their ability to resist breakage. For example, the quality of one or more apertures provided in brittle articles can affect breakage levels and thus can be monitored and/or adjusted through testing.

The invention can be implemented in numerous ways, including as a method, system, device, or apparatus. Several embodiments of the invention are discussed below.

As a system for testing a glass article having at least one aperture against breakage criteria, one embodiment can, for example, include at least a retainer apparatus and a loading apparatus. The retainer apparatus can be configured to releasably retain the glass article to be tested. The retainer apparatus can secure a portion of the glass article between first and second plates, with the portion of the glass article being retained not including the at least one aperture, and a remaining portion of the glass article can having the at least one aperture remains outside of the retainer apparatus. The loading apparatus can be configured to apply a test load at a first predetermined location on the remaining portion of the glass article.

As an apparatus for destructive testing of a first aperture extending through a substantially brittle item, the first aperture having a first aperture wall, one embodiment can, for example, include at least (i) a retainer assembly configured to releasably retain a first extremity of the substantially brittle item, while an opposing extremity of the substantially brittle item, including the first aperture, remains unretained by the retainer assembly; and (ii) a load assembly configured to apply a breaking load and/or a breaking load displacement at a predetermined location of the opposing extremity of the substantially brittle item, so as to originate fracture of the substantially brittle item at the first aperture wall of the first aperture.

As a system for processing substantially brittle cover items for consumer electronic products, wherein each of the substantially brittle cover items has a respective first aperture wall of a respective first aperture extending therethrough, one embodiment can, for example, include at least a cover item polishing assembly configured to polish the respective first aperture wall of the respective first aperture of each of the substantially brittle cover items; and an aperture wall quality monitor configured to monitor quality of one or more of the substantially brittle cover items for consumer electronic products.

As a consumer electronic product, one embodiment can, for example, include at least a housing having a surface, electrical components provided at least partially internal to the housing, the electrical components including at least an illuminator, a camera, a processor and a memory, the illuminator being provided at or adjacent the surface of the housing, and a cover item having a first aperture wall of a first aperture extending therethrough provided at or over the surface of the housing such that it is provided over the camera, the first aperture wall being polished using a monitored aperture wall polishing assembly.

As a method for producing substantially brittle cover item for consumer electronic products, one embodiment can, for example, include at least: obtaining a substantially brittle cover item for consumer electronic products, the substantially brittle cover item having a first aperture wall of a first aperture extending therethrough; polishing the first aperture wall of the first aperture of each of the substantially brittle cover items; and monitoring the polishing of the first aperture wall of the first aperture of the substantially brittle cover item.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals may designate like structural elements, and in which:

FIG. 1 is a block diagram of a system according to one embodiment.

FIGS. 2A-2C are simplified depictions of a retainer assembly according to one embodiment.

FIGS. 3A-3C are simplified depictions of applying a breaking load according to one embodiment.

FIGS. 4A and 4B are simplified cross-sectional depictions of applying a breaking load displacement according to one embodiment.

FIGS. 5A and 5B are diagrammatic representations of an electronic device according to one embodiment.

FIG. 6 is a flow diagram of a process according to one embodiment.

FIG. 7 is a block diagram of a controller according to one embodiment.

### DETAILED DESCRIPTION OF EMBODIMENTS OF THE INVENTION

The invention relates generally to testing brittle articles, such as glass or ceramic articles. The testing is provided by a test apparatus that imposes a bending test to a brittle article. The testing is also well suited for testing small scale brittle articles which are too small to utilize conventional multi-point testing or ring-on-ring testing. In addition, the testing is also well suited for testing brittle articles that have one or more apertures (or holes) therein which can impact their ability to resist breakage. For example, the quality of one or more apertures provided in brittle articles can affect breakage levels and thus can be monitored and/or adjusted through testing.

Embodiments of the invention can relate to apparatus, systems and methods for testing, processing and monitoring cover items for electronic devices. In one embodiment, the cover items can pertain to housing surfaces of the electronic devices. Typically, the cover items are formed of glass or ceramic, or other substantially brittle material.

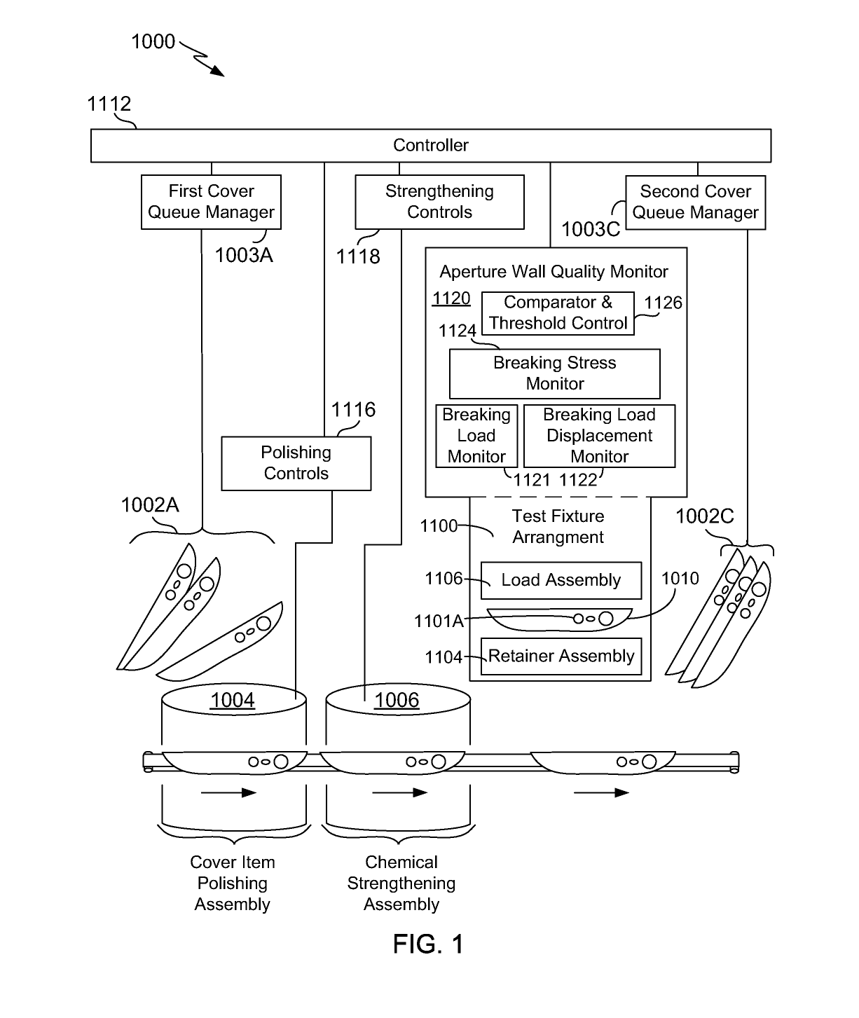

Embodiments of the invention are discussed below with reference to FIGS. 1-7. However, those skilled in the art will readily appreciate that the detailed description given herein with respect to these figures is for explanatory purposes as the invention extends beyond these limited embodiments. The illustrations provided in these figures are not necessarily drawn to scale; instead, the illustrations are presented in a manner to facilitate presentation.

FIG. 1 is a block diagram of a system 1000 according to one embodiment. System 1000 can process and monitor cover items for consumer electronic products.

FIG. 1 shows covers items undergoing various stages of processing. Cover items 1002A waiting processing and monitoring can be managed by a first queue manager 1003A for organizing and/or tracking waiting cover items. Processed cover items 1002C can be managed by a second queue manager 1003C for organizing and/or tracking cover items that have been processed. A conveyor mechanism may convey cover items as they progress through system 1000.

In FIG. 1 a first notional arrow extends from the cover items 1002A to be processed, and extends towards the another cover item, which is being polished by cover item polishing assembly 1004, so as to show processing progress of system 1000. Cover items, and in particular apertures extending through cover items, can be polished in various ways. For cover item polishing assembly 1004, various polishing parameters, such as one or more of polishing time, polishing compound or polishing speed, can be controlled. As one example, polishing time may be changed and/or controlled and/or adjusted. As another example, polishing compound may be refreshed or replaced. As still another example, polishing speed may be changed and/or controlled and/or adjusted using polishing controls 1116. Polishing out defects from the aperture walls of the cover items may help to increase strength so as to limit fracture occurrence at the aperture in response to a load and/or load displacement and/or stress imposed on the cover items.

Once polishing is complete, cover items can be removed from cover item polishing assembly 1004. At this point, the cover item has been polished. Cover items that have been polished can be chemically strengthened at chemical strengthening assembly 1006.

In FIG. 1 a second notional arrow extends from the cover item that has just been polished, and extends towards yet another cover item, which is being chemically strengthened by chemical strengthening assembly 1006, so as to show further processing progress of system 1000. Cover items, including any apertures extending through cover items, can be chemically strengthened in various ways. Glass cover items may be chemically strengthened by submersing the glass cover in a heated potassium (KOH) bath of chemical strengthening assembly 1006 for a sufficient period of time. For chemical strengthening assembly 1006, various chemical strengthening parameters such as chemical strengthening time may be changed and/or controlled and/or adjusted, and/or chemical strengthening liquid may be refreshed, and/or chemical strengthening bath temperature may be changed and/or controlled and/or adjusted, using strengthening controls 1118. Chemical strengthening the cover items, including the aperture walls, may help to limit fracture occurrence in response to breaking load and/or breaking load displacement and/or breaking stress.

In FIG. 1 a third notional arrow extends from the cover item that has just been chemically strengthened, and extends towards the queue of processed cover items 1002C, so as to show further processing progress of system 1000. However, it should be understood that one or more apertures of one or more of the processed cover items can be monitored using an aperture wall quality monitor 1120. The aperture wall quality monitor 1120 may be configured to monitor of one or more of the cover items for consumer electronic products.

In particular, the aperture wall quality monitor 1120 may be configured to monitor polishing of a first aperture wall 1101A of a first aperture of at least one of the cover items 1010, which may be substantially brittle. The aperture wall quality monitor 1120 may include a test fixture arrangement 1100 for destructive testing of at least the first aperture wall 1101A of the first aperture of at least one of the cover items 1010.

As will be discussed in greater detail subsequently herein, test fixture arrangement 1100 may comprise a retainer assembly 1104, which may be configured to releasably retain a first extremity of the cover item 1010 adjacent to the first aperture wall 1101A of the first aperture, while an opposing extremity of the cover item 1010 remains unretained by the retainer assembly. A load assembly 1106 may be configured to apply a breaking load and/or a breaking load displacement and/or a breaking stress at a predetermined location of the opposing extremity 1010B of the cover item 1010, so as to originate fracture from the first aperture wall 1101A of the first aperture.

The breaking load and/or breaking load displacement and/or breaking stress may be applied at a predetermined location of the opposing extremity between the first aperture and the second aperture of the cover item 1010. Further, the breaking load and/or breaking load displacement and/or breaking stress may be applied at the predetermined location between the first aperture and the third aperture of the cover item. Instrumentation available from Instron (Instron, Norwood, Mass. USA) may, for example, be integrated into various components of system 1000.

The aperture wall quality monitor 1120 may comprise a breaking load monitor 1121, which may be configured to monitor a breaking load of the first aperture wall 1101A of the first aperture of at least one of the cover items 1010. Further, the aperture wall quality monitor 1120 may comprise a breaking load displacement monitor 1122, which may be configured to monitor a breaking load displacement of the first aperture wall 1101A of the first aperture of at least one of the cover items 1010. Additionally, the aperture wall quality monitor 1120 may comprise a breaking stress monitor 1124, which may be configured to monitor a breaking stress of the first aperture wall 1101A of the first aperture of at least one of the cover items 1010. Breaking stress may be calculated and may be based at least in part on the breaking load and the breaking load displacement.

Accordingly, it should be understood that aperture wall quality monitor may monitor the chemical strengthening and/or polishing of the cover items by monitoring a breaking load and/or breaking load displacement and/or breaking stress, such as at the first aperture wall 1101A of the first aperture of at least one of the cover items 1010. Monitoring the chemical strengthening and/or polishing may comprise applying the breaking load and/or breaking load displacement and/or breaking stress at the predetermined location.

System 1000 may further comprise a controller 1112. Controller 1112 may comprise a communication interface, processing system, storage system, and user interface. The processing system of controller 1112 may be operatively coupled to a storage system. Storage system of controller 1112 may store software and data.

Controller 1112 may be coupled with the polishing controls 1116 and/or the cover item polishing assembly 1004 for controlling at least one processing parameter of the cover item polishing assembly. Controller 1112 may be coupled with the aperture wall quality monitor 1120 for receiving a monitor signal that is substantially related to polishing quality of the respective first aperture wall of the respective first aperture of each of the cover items. Controller 1112 may be coupled with the aperture wall quality monitor 1120 for receiving a monitor signal that is substantially related to polishing quality of the cover items. The controller 1112 may be configured to generate an indicator signal when the polishing quality of the cover items provided by the cover item polishing assembly 1004 should be adjusted, based at least in part on the monitor signal.

Aperture wall quality monitor 1120 may be configured to monitor strength of the first aperture wall 1101A of the first aperture 1101 of at least one of the cover items 1010. Controller 1112 may be coupled with the chemical strengthening assembly 1006 for controlling at least one processing parameter of the chemical strengthening assembly 1006. Controller 1112 may be coupled with the aperture wall quality monitor 1120 for receiving a monitor signal that is substantially related to strength of the first aperture wall 1101A of the first aperture of at least one of the cover items 1010.

Controller 1112 may be coupled with the aperture wall quality monitor 1120 for receiving a monitor signal that is substantially related to strength of the first aperture wall of the first aperture of at least one of the cover items. Controller 1112 may be configured to generate an indicator signal when strength of the cover items should be adjusted, based at least in part on the monitor signal.

Accordingly, it should be understood that controller 1112 may control one or more processing parameters based upon the monitoring of one or more apertures. Controller 1112 may control processing based at least in part upon the monitoring of one or more apertures. Controller 1112 may control one or more processing parameters of the chemical strengthening assembly 1006 based upon the monitoring of one or more apertures. Similarly, controller 1112 may control one or more processing parameters of the cover item polishing assembly based upon the monitoring of one or more apertures.

With respect to the controller 1112 controlling one or more processing parameters, it should be understood that at least one processing parameter of the chemical strengthening and/or polishing may be adjusted in response to the monitoring. The monitoring may comprise generating a signal value that is substantially related to chemical strengthening quality and/or polishing quality of the cover items. A comparator and threshold control 1126 may compare a predetermined threshold value to the signal value that is substantially related to the chemical strengthening quality and/or polishing quality of the cover items.

Based at least in part on the monitoring of the chemical strengthening and/or polishing, the controller 1112 may determine that there is to be an adjustment to the quality of the polishing. There may be adjustment of quality of the chemical strengthening and/or quality of the polishing, based at least in part on the monitoring of the chemical strengthening and/or polishing.

For example, as mentioned previously herein, the controller 1112 may extend (and/or change and/or control and/or adjust) polishing time, and/or may refresh the polishing compound, and/or may change and/or control and/or adjust polishing speed, based at least in part on the monitoring of the polishing. The foregoing may increase effectiveness of polishing out defects from the aperture wall, which in turn may help to limit fracture occurrence as breaking load and/or breaking load displacement and/or breaking stress are increased.

Similarly, as mentioned previously herein, the controller 1112 may extend (and/or change and/or control and/or adjust) chemical strengthening time, and/or may refresh the chemical strengthening liquid, and/or may change and/or control and/or adjust chemical strengthening bath temperature, based at least in part on the monitoring of the chemical strengthening. The foregoing may increase effectiveness of chemical strengthening of the aperture wall, which in turn may help to limit fracture occurrence as breaking load and/or breaking load displacement and/or breaking stress are increased.

The cover items 1010 being processed by system 1000 are able to be tested with respect to quality criteria. The quality criteria can be a strength requirement for the cover items 1010. When the cover items 1010 include one or more apertures, system can also test the quality (e.g., strength) of the cover items 1010 at the vicinity of the one or more apertures, since apertures can be weak points in the cover items 1010. The testing can be destructive, in which case the cover item(s) are broken by a imposed breaking load, displacement or stress, or the testing can be non-destructive, in which case the cover items(s) that meet the quality criteria do not break. The testing can be of a random sampling of cover items 1010 be produced, or can be near-real time testing in-line with the other processing operations on the cover items 1010.

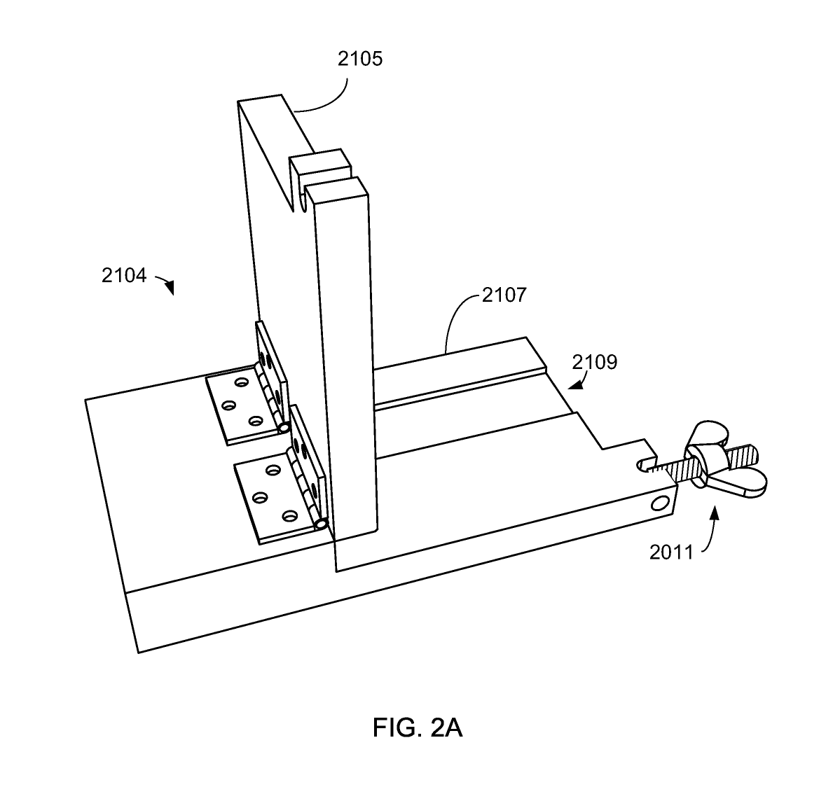

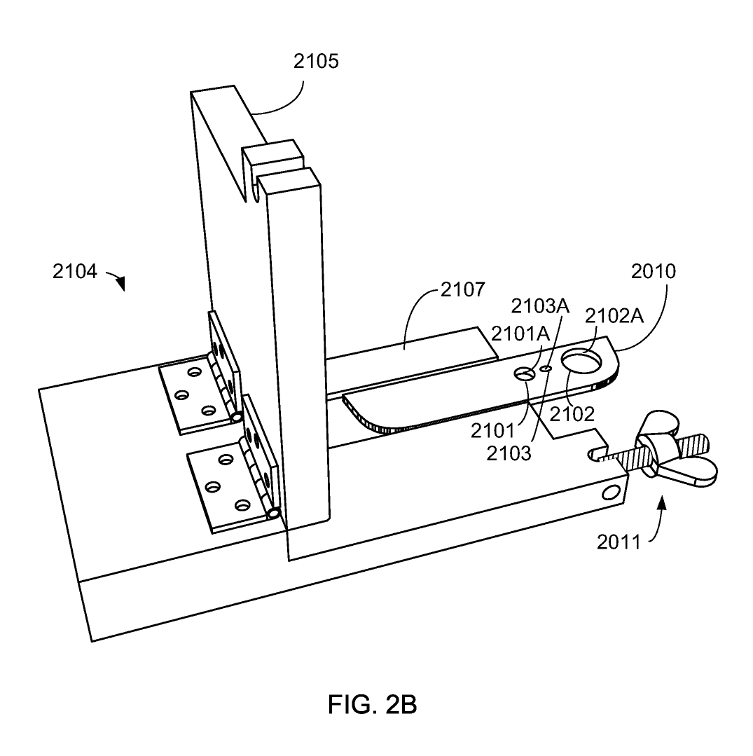

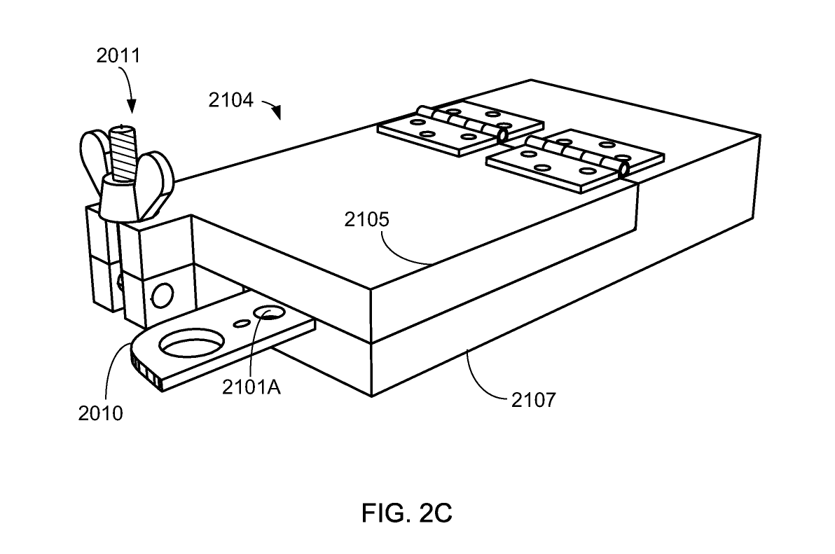

FIGS. 2A-2C are a series of simplified depictions of a retainer assembly 2104 according to one embodiment. First and second plates 2105, 2107 of retainer assembly 2104 are shown in an open position in FIGS. 2A and 2B. First and second plates 2105, 2107 of retainer assembly 2104 are shown in a closed position and/or clamped position in a clamshell arrangement for securing and/or sandwiching cover item 2010 therebetween in FIG. 2C. In FIG. 2C a threaded fastener and wingnut combination 2011 is shown clamping first and second plates 2105, 2107 of retainer assembly 2104, so as to secure and/or sandwich a cover item 2010 to be tested therebetween.

FIG. 2A particular shows a recess 2109 in second plate 2107 of retainer assembly 2104 for receiving the cover item 2010 to be tested. FIG. 2B shows a first extremity of the cover item 2010 disposed in the recess of the second plate 2017 while the plates 2105, 2107 are open. The cover item 2010 may have first aperture 2101 (and its first aperture wall 2101A), and may have second aperture 2102 (and its second aperture wall 2102A), and may have third aperture 2103 (and its third aperture wall 2103A) extending therethrough.

As already mentioned previously herein, FIG. 2C shows first and second plates 2105, 2107 of retainer assembly 2104 in closed position and/or clamped in the clamshell arrangement for securing and/or sandwiching cover item 2010 therebetween. As particularly shown in FIG. 2C, retainer assembly 2104 may be configured to releasably retain the first extremity of the cover item 2010 adjacent to the first aperture wall 2101A of the first aperture, while an opposing extremity of the cover item 2010 remains unretained by the retainer assembly 2104.

Although the cover item 2010 shown in FIGS. 2A-2C has three (3) apertures, in general, the cover item 2010 can have none, one or multiple apertures. The testing apparatus and techniques described herein are particularly well suited for testing cover items, particularly small scale cover items, that have one or more apertures. As an example, a small scale cover item can be have a height and width of not more that 20 cm×20 cm, or more particularly 10 cm×10 cm. As a specific example, the cover item 2010 shown in FIGS. 2A-2C, which is an exemplary cover item, can have a height and width of approximately 2 cm×6 cm.

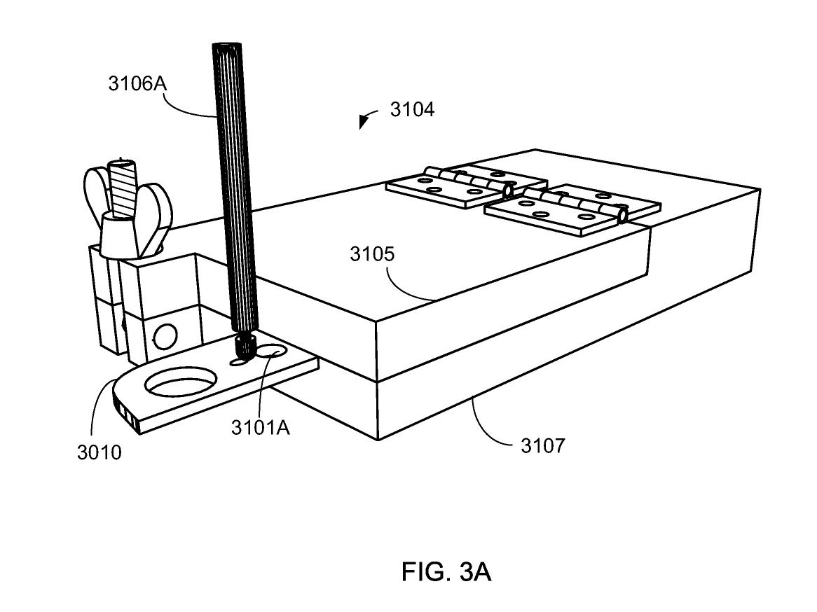

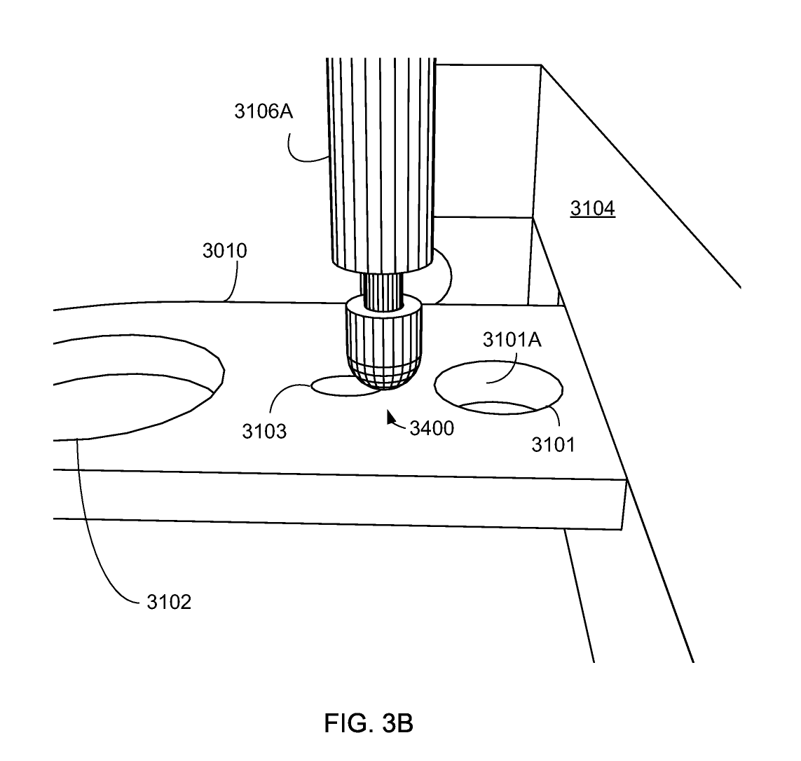

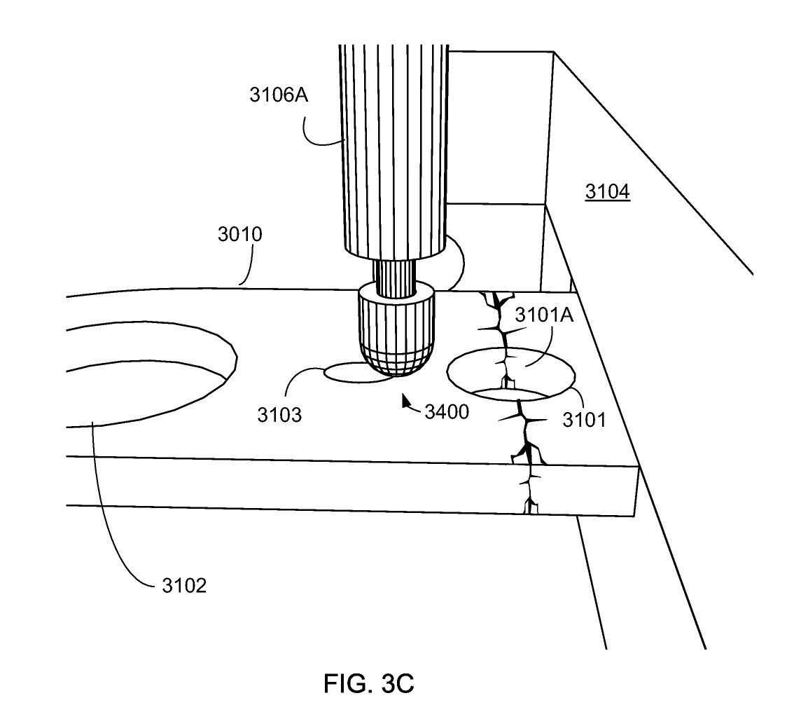

FIGS. 3A-3C are simplified depictions in various views of applying a breaking load according to one embodiment. As shown, retainer assembly 3104 may be configured to releasably retain a first extremity of the cover item 3010 near a first aperture wall 3101A of a first aperture, while an opposing extremity (including the first aperture) of the cover item 3010 remains unretained by the retainer assembly 3104. Here, the first aperture can be positioned adjacent or proximate the end of the retainer assembly 3104. Isometric view of FIG. 3A provides full view of first and second plates 3105, 3107 of retainer assembly 3104 in a closed position. As shown in FIG. 3A, a portion (first extremity) of the cover item 3010 is retained therein. FIG. 3B is a detailed view of what is shown in FIG. 3A.

The breaking load may be applied by a tip portion 3106A of load assembly at a predetermined location 3400 of the opposing extremity so that fracture originates from the first aperture wall 3101A of the first aperture 3101. As a result, the breaking load at the first aperture 3101 can be evaluated or quantified.

The breaking load and/or breaking load displacement and/or breaking stress may be applied at the predetermined location 3400 between the first aperture 3101 and the second aperture 3102. The breaking load and/or breaking load displacement and/or breaking stress may be applied at the predetermined location between the first aperture 3101 and the third aperture 3103.

FIG. 3C is arranged in series after FIGS. 3A and 3B so as to illustrate fracture and breaking load. In FIGS. 3A and 3B full breaking load is not yet applied and fracture has not yet occurred. In FIG. 3C, full breaking load and/or breaking load displacement and/or breaking load stress has been applied and fracture has occurred.

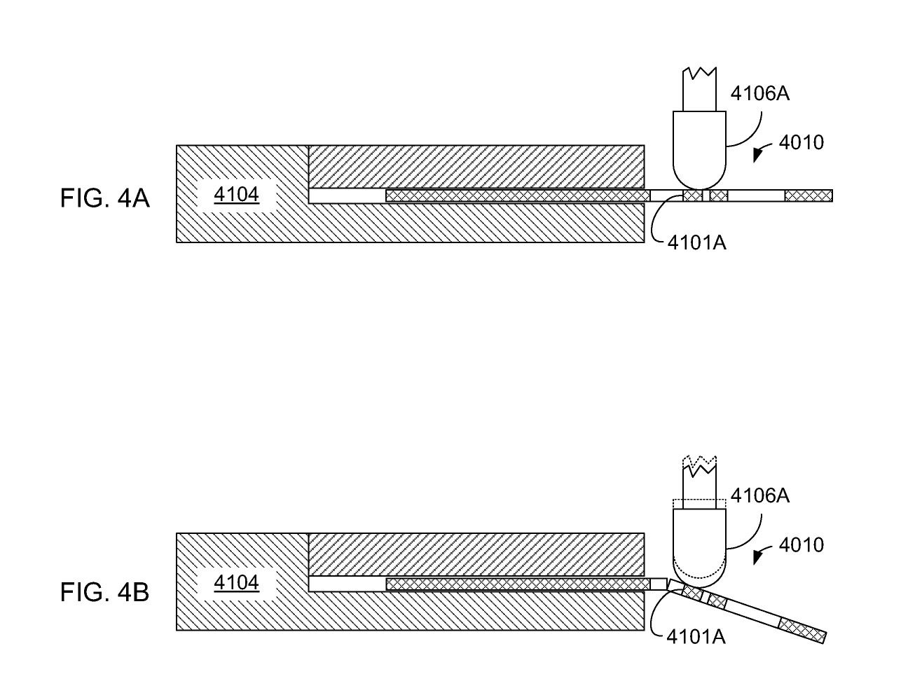

FIGS. 4A and 4B are simplified cross-sectional depictions of applying a breaking load displacement to cover item 4010 according to one embodiment. As shown retainer assembly 4104 may be configured to releasably retain a first extremity of cover item 4010 near a first aperture wall 4101A of a first aperture, while an opposing extremity (including the first aperture) of the cover item 4010 remains unretained by the retainer assembly 4104. Here, the first aperture can be positioned adjacent or proximate the end of the retainer assembly 4104. The breaking load displacement may be applied by a tip portion 4106A of load assembly at a predetermined location of the opposing extremity so that fracture originates from the first aperture wall 4101A.

FIGS. 4A and 4B are arranged in series so as to illustrate fracture and breaking load displacement. In FIG. 4A full breaking load displacement is not yet applied and fracture has not yet occurred. In FIG. 4B full breaking load displacement has been applied and fracture has occurred.

Breaking load displacement of the aperture wall 4101A of cover item 4010 may be small, and may be on the order of one or two millimeters, just as fracture is about to occur and occurs. Accordingly, it should be understood that in FIG. 4B the breaking load displacement of the aperture wall 4101A of cover item 4010, as well as the dashed line to solid line depiction of displacement of the tip portion 4106A of the load assembly, are all shown as greatly exaggerated for ease of illustration.

Additionally, it should be understood that to test quality (i.e., strength or breakage load) of other portions of cover item 4010, the tip portion 4106A would be repositioned. For example, to test the quality of cover item 4010 at another aperture, the tip portion 4106A would be repositioned to concentrate the load over the another aperture. The placement of cover item 4010 in the retainer assembly 4104 might also be adjusted.

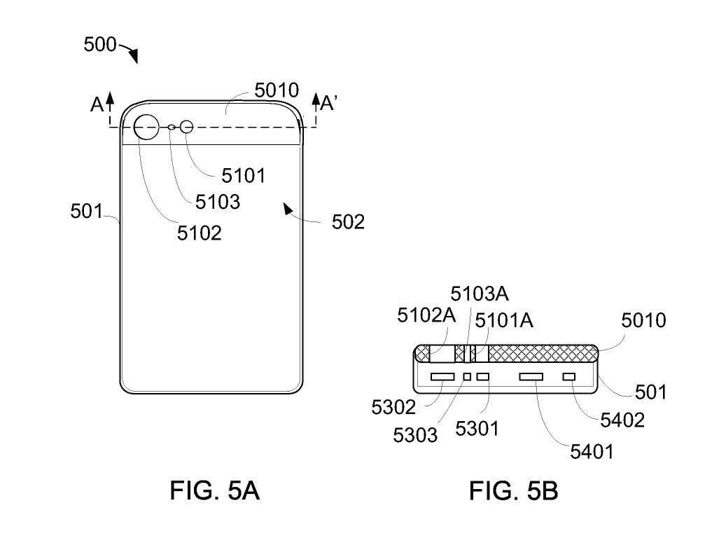

FIGS. 5A and 5B are diagrammatic representations of an electronic device 500 according to one embodiment. FIG. 5A illustrates a top view for the electronic device 500, and FIG. 5B illustrates a cross-sectional side view for electronic device 500 with respect to reference line A-A′. Electronic device 500 may comprise a housing 501 having a surface 502.

Electrical components 5301, 5302, 5303, 5401, 5402 may be provided at least partially internal to the housing. These electrical components can, for example, correspond to an illuminator 5301, a camera 5302, a microphone 5303, a processor 5401, and a memory 5402. The illuminator 5301 and/or the camera 5302 and/or a third electrical component may be provided adjacent the surface 502 of the housing 501.

Cover item 5010 is typically made of a material that is substantially brittle. In one embodiment, cover item 5010 may formed of glass, and in particular may comprise chemically strengthened glass. In other embodiments, cover item 5010 may be formed of ceramic or another material.

As shown in the figures, cover item 5010 may have a first aperture wall 5101A of a first aperture 5101 extending therethrough. This may be provided at or over the surface 502 of the housing 501, such that it is provided over the illuminator 5301. The first aperture wall 5101A may be monitored, and may be polished using a monitored aperture wall polishing assembly, as discussed previously herein. The first aperture wall 5101A may be monitored, and may be chemically strengthened using a monitored chemical strengthening assembly, as discussed previously herein.

As shown in the figures, cover item 5010 may have a second aperture wall 5102A of a second aperture 5102 extending therethrough. This may be provided at or over the surface 502 of the housing 501, such that it is provided over the camera 5302. The second aperture wall 5102A may be monitored, and may be polished using the monitored aperture wall polishing assembly, as discussed previously herein. The second aperture wall 5102A may be monitored, and may be chemically strengthened using the monitored chemical strengthening assembly, as discussed previously herein.

As shown in the figures, cover item 5010 may have a third aperture wall 5103A of a third aperture 5103 extending therethrough. This may be provided at or over the surface 502 of the housing 501, such that it is provided over the third electrical component 5303. The third aperture wall 5103A may be monitored, and may be polished using the monitored aperture wall polishing assembly, as discussed previously herein. The third aperture wall 5103A may be monitored, and may be chemically strengthened using the monitored chemical strengthening assembly, as discussed previously herein.

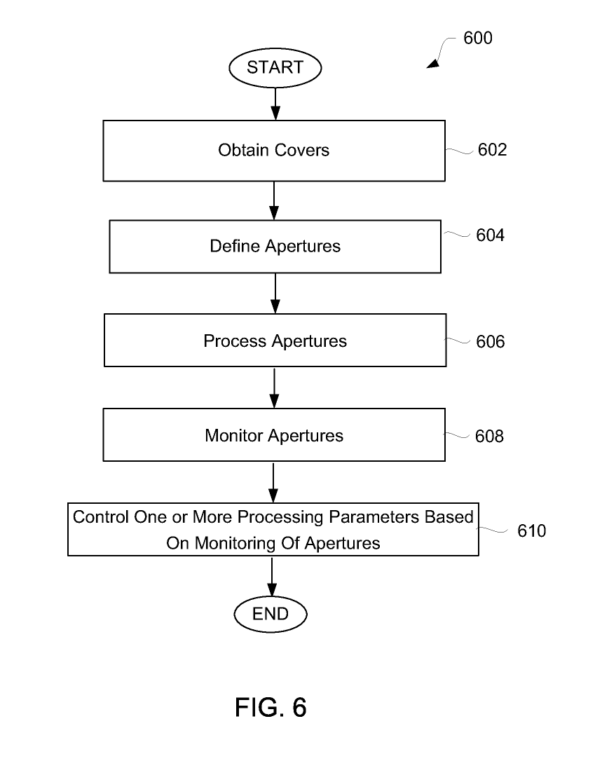

FIG. 6 is a flow diagram of a process 600 according to one embodiment. The process 600 can serve to produce cover items for consumer electronic products. The process 600 can begin with obtaining 602 cover items for consumer electronic products. Typically, the cover items are substantially brittle, such as glass or ceramic. Glass cover items may be obtained, in one embodiment, after a glass sheet is singulated into glass pieces. In other embodiments, the cover items may be ceramic or made from other materials.

The process can continue with defining 604 one or more respective apertures extending into each of the cover items. A drilling or machining process may be used to form the one or more respective apertures. A respective first aperture wall of a respective first aperture may extend into each of the cover items. In some embodiments, one or more additional apertures may be defined in each of the cover items. A respective second aperture wall of a respective second aperture may extend into each of the cover items. A respective third aperture wall of a respective third aperture may extend into each of the cover items.

The process 600 can continue with processing 606 the apertures. For example, the processing 606 may comprise chemically strengthening 606 and/or polishing 606 the apertures. The respective first aperture wall of the respective first aperture of each of the cover items may be chemically strengthened and/or polished (e.g., chemically strengthening and/or polishing). In some embodiments, one or more additional apertures may be processed in each of the cover items. A respective second aperture wall of a respective second aperture of each of the cover items may be chemically strengthened and/or polished. A respective third aperture wall of a respective third aperture of each of the cover items may be chemically strengthened and/or polished.

The process 600 can continue with monitoring 608 the apertures. For example, the monitoring 608 may comprise monitoring the chemically strengthening and/or polishing of the apertures. The chemically strengthening and/or polishing of respective first aperture wall of the respective first aperture of each of the cover items may be monitored (e.g., monitor chemically strengthening and/or monitor polishing).

In some embodiments, one or more additional apertures may be monitored for each of the cover items. Chemical strengthening and/or polishing of a respective second aperture wall of a respective second aperture of each of the cover items may be monitored. Chemical strengthening and/or polishing of a respective third aperture wall of a respective third aperture of each of the cover items may be monitored.

Monitoring 608 the chemical strengthening and/or polishing may comprise destructive testing of one or more apertures of at least one of the cover items. For example, monitoring 608 the chemical strengthening and/or polishing may comprise destructive testing of the first aperture wall of the first aperture of at least one of the cover items. In particular, monitoring the chemical strengthening and/or polishing may comprise originating fracture from the first aperture wall of the first aperture of at least one of the cover items. Similarly, monitoring the chemical strengthening and/or polishing may comprise originating fracture from the second aperture wall of the second aperture of at least one of the cover items. Furthermore, monitoring the chemical strengthening and/or polishing may comprise originating fracture from the third aperture wall of the third aperture of at least one of the cover items.

Monitoring 608 the chemical strengthening and/or polishing may comprise monitoring a breaking load and/or breaking load displacement and/or breaking stress of the first aperture wall of the first aperture of at least one of the cover items. Monitoring 608 the chemical strengthening and/or polishing may comprise applying the breaking load and/or breaking load displacement and/or breaking stress at a predetermined location between the first aperture and the second aperture. Further, monitoring 608 the chemical strengthening and/or polishing may comprise applying the breaking load and/or breaking load displacement and/or breaking stress at the predetermined location between the first aperture and the third aperture.

Further, monitoring the chemical strengthening and/or polishing may comprise monitoring a breaking load and/or breaking load displacement and/or breaking stress of the second aperture wall of the second aperture of at least one of the cover items. Monitoring the chemical strengthening and/or polishing may comprise monitoring a breaking load and/or breaking load displacement and/or breaking stress of the third aperture wall of the third aperture of at least one of the cover items.

The process 600 can continue with controlling 610 one or more processing parameters based upon the monitoring of one or more apertures. The processing may be controlled, for example by the controller as discussed previously herein with reference to FIG. 1, based at least in part upon the monitoring of one or more apertures. One or more processing parameters of the chemical strengthening may be controlled based upon the monitoring of one or more apertures. Similarly, one or more processing parameters of the polishing may be controlled based upon the monitoring of one or more aperture. Following block 610, process 600 can end.

With respect to the controlling 610 of one or more processing parameters in the process 600, it should be understood that at least one processing parameter of the chemical strengthening and/or polishing may be adjusted in response to the monitoring. The monitoring may comprise generating a signal value that is substantially related to chemical strengthening quality and/or polishing quality of the cover items. A predetermined threshold value may be compared to the signal value that is substantially related to the chemical strengthening quality and/or polishing quality of the cover items.

Based at least in part on the monitoring of the chemical strengthening and/or polishing, there may be a determining that there is to be adjustment of quality of the polishing. There may be adjusting of quality of the chemical strengthening and/or quality of the polishing, based at least in part on the monitoring of the chemical strengthening and/or polishing.

For example, polishing time may be extended (and/or changed and/or controlled and/or adjusted), and/or polishing compound may be refreshed, and/or polishing speed may be changed and/or controlled and/or adjusted, based at least in part on the monitoring of the polishing. The foregoing may increase effectiveness of polishing out defects from the aperture wall, which in turn may help to limit fracture occurrence as breaking load and/or breaking load displacement and/or breaking stress are increased.

Similarly, chemical strengthening time may be extended (or changed and/or controlled and/or adjusted), and/or chemical strengthening liquid may be refreshed, and/or chemical strengthening bath temperature may be changed and/or controlled and/or adjusted, based at least in part on the monitoring of the chemical strengthening. The foregoing may increase effectiveness of chemical strengthening of the aperture wall, which in turn may help to limit fracture occurrence as breaking load and/or breaking load displacement and/or breaking stress are increased.

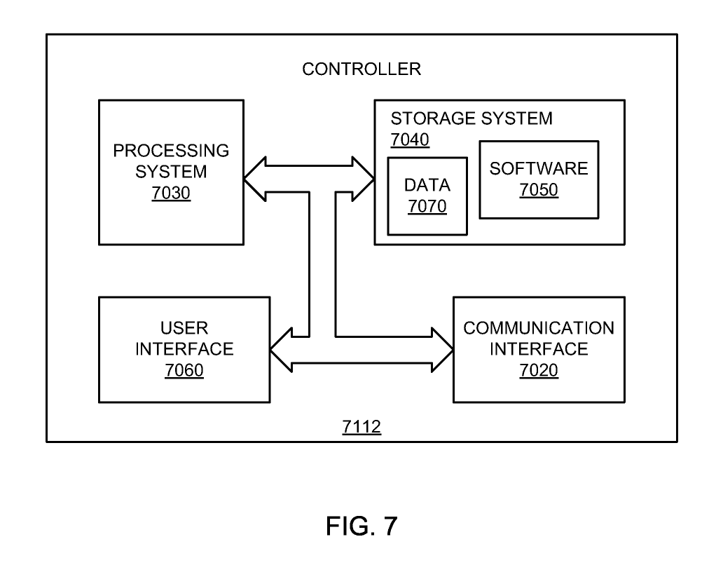

FIG. 7 is a block diagram of a controller 7112 according to one embodiment. Controller 7112 can includes communication interface 7020, processing system 7030, storage system 7040, and user interface 7060. Processing system 7030 can be operatively coupled to storage system 7040. Storage system 7040 can store software 7050 and data 7070.

The apparatus and processes described herein may be applied to cover items, for example glass cover items, which may be used by any of a variety of electronic devices including but not limited handheld electronic devices, portable electronic devices and substantially stationary electronic devices. By way of example, and not by way of limitation, the electronic device may correspond to media players, mobile phones (e.g., cellular phones), PDAs, remote controls, notebooks, tablet PCs, monitors, all in one computers and the like.

Some embodiments may be implemented by software, but can also be implemented in hardware or a combination of hardware and software. Some implementations may be embodied as computer readable code on a tangible computer readable medium. The tangible computer readable medium is any data storage device that can store data, which can thereafter be read by a computer system. Examples of tangible computer readable medium include read-only memory, random-access memory, CD-ROMs, DVDs, magnetic tape, and optical data storage devices.

The various aspects, features, embodiments or implementations of the invention described above can be used alone or in various combinations.

Different aspects, embodiments or implementations may, but need not, yield one or more of the following advantages. One advantage of certain embodiments is that small scale brittle materials can undergo breakage testing. Another advantage of certain embodiment is that breakage testing can be performed to evaluate breakage conditions associate with apertures of a glass article (such as a cover glass for a consumer electronic device). Still another advantage of certain embodiments is that automated control and/or monitoring of cover items with apertures can be performed with greater accuracy, efficiency and/or consistency.

Although only a few embodiments of the invention have been described, it should be understood that the invention may be embodied in many other specific forms without departing from the spirit or scope of the present invention. By way of example, the steps associated with the methods of the invention may vary widely. Steps may be added, removed, altered, combined, and reordered without departing from the spirit or scope of the invention. Similarly, while operations are depicted in the drawings in a particular order, this should not be understood as requiring that such operations be performed in the particular order shown or in sequential order, or that all illustrated operations be performed, to achieve desirable results.

While this specification contains many specifics, these should not be construed as limitations on the scope of the disclosure or of what may be claimed, but rather as descriptions of features specific to particular embodiment of the disclosure. Certain features that are described in the context of separate embodiments can also be implemented in combination. Conversely, various features that are described in the context of a single embodiment can also be implemented in multiple embodiments separately or in any suitable subcombination. Moreover, although features may be described above as acting in certain combinations, one or more features from a claimed combination can in some cases be excised from the combination, and the claimed combination may be directed to a subcombination or variation of a subcombination.

While this invention has been described in terms of several embodiments, there are alterations, permutations, and equivalents, which fall within the scope of this invention. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. A system for testing a glass article having at least one aperture against breakage criteria, comprising:
a retainer apparatus configured to releasably retain the glass article to be tested, the retainer apparatus securing a portion of the glass article between first and second plates, the portion of the glass article being retained does not include the at least one aperture, and a remaining portion of the glass article having the at least one aperture remains outside of the retainer apparatus; and
a loading apparatus configured to apply a test load at a first predetermined location on the remaining portion of the glass article.

2. A system as recited in claim 1, wherein strength of the glass article at the at least one aperture is able to be evaluated.

3. A system as recited in claim 1, wherein the applied test load serves to initiate a fracture at the at least one aperture.

4. A system as recited in claim 1, wherein the test load is gradually increased until the remaining portion of the glass article fractures.

5. A system as recited in claim 1, wherein the glass article includes at least a first aperture and a second aperture,
wherein the loading apparatus is further configured, after to removing the test load, to subsequently apply another test load at a second predetermined location on the remaining portion of the glass article.

6. A system as recited in claim 1, wherein strength of the glass article at the second aperture is able to be evaluated.

7. An apparatus for destructive testing of a first aperture extending through a substantially brittle item, the first aperture having a first aperture wall, the apparatus comprising:
a retainer assembly configured to releasably retain a first extremity of the substantially brittle item, while an opposing extremity of the substantially brittle item, including the first aperture, remains unretained by the retainer assembly; and
a load assembly configured to apply a breaking load and/or a breaking load displacement at a predetermined location of the opposing extremity of the substantially brittle item, so as to originate fracture of the substantially brittle item at the first aperture wall of the first aperture.

8. An apparatus as recited in claim 7 wherein the retainer assembly comprises a first plate and a second plate configured to sandwich the substantially brittle item therebetween.

9. An apparatus as recited in claim 7 further comprising a breaking load monitor coupled with the load assembly and configured to monitor the breaking load of the substantially brittle item.

10. An apparatus as recited in claim 7 further comprising a breaking load displacement monitor coupled with the load assembly and configured to monitor the breaking load displacement of the substantially brittle item.

11. An apparatus as recited in claim 7 further comprising a breaking stress monitor coupled with the load assembly and configured to monitor breaking stress, based at least in part on the breaking load and the breaking load displacement.

12. An apparatus as recited in claim 11,
wherein the substantially brittle item further has a second aperture extending through the substantially brittle item, the second aperture having a second aperture wall, and
wherein the load assembly is configured to apply the breaking load and/or the breaking load displacement at the predetermined location between the first aperture and the second aperture.

13. An apparatus as recited in claim 12,
wherein the substantially brittle item further has a third aperture extending through the substantially brittle item, the third aperture having a third aperture wall, and
wherein the load assembly is configured to apply the breaking load and/or the breaking load displacement at the predetermined location between the first aperture and the third aperture.

14. A system for processing substantially brittle cover items for consumer electronic products, wherein each of the substantially brittle cover items has a respective first aperture wall of a respective first aperture extending therethrough, the system comprising:
a cover item polishing assembly configured to polish the respective first aperture wall of the respective first aperture of each of the substantially brittle cover items; and
an aperture wall quality monitor configured to monitor quality of one or more of the substantially brittle cover items for consumer electronic products.

15. A system as recited in claim 14 wherein the aperture wall quality monitor is configured to monitor the polishing of the first aperture wall of the first aperture of at least one of the substantially brittle cover items.

16. A system as recited in claim 14 wherein the aperture wall quality monitor comprises an apparatus for destructive testing of the first aperture wall of the first aperture of at least one of the substantially brittle cover items.

17. A system as recited in claim 14 wherein the aperture wall quality monitor comprises a load assembly configured to originate fracture from the first aperture of at least one of the substantially brittle cover items.

18. A system as recited in claim 14 wherein the aperture wall quality monitor comprises a breaking load monitor configured to monitor a breaking load of the first aperture wall of the first aperture of at least one of the substantially brittle cover items.

19. A system as recited in claim 14 wherein the aperture wall quality monitor comprises a breaking load displacement monitor configured to monitor a breaking load displacement of the first aperture wall of the first aperture of at least one of the substantially brittle cover items.

20. A system as recited in claim 14 wherein the aperture wall quality monitor comprises a breaking stress monitor configured to monitor a breaking stress of the first aperture wall of the first aperture of at least one of the substantially brittle cover items.

21. A system as recited in claim 14 further comprising a controller coupled with the cover item polishing assembly for controlling at least one processing parameter of the cover item polishing assembly.

22. A system as recited in claim 14 further comprising a controller coupled with the aperture wall quality monitor for receiving a monitor signal that is substantially related to polishing quality of the first aperture wall of the first aperture of at least one of the substantially brittle cover items.

23. A system as recited in claim 14 further comprising a controller,
wherein the controller is coupled with the aperture wall quality monitor for receiving a monitor signal that is substantially related to polishing quality of the substantially brittle cover items, and
wherein the controller is configured to generate an indicator signal when the polishing quality of the substantially brittle cover items provided by the cover item polishing assembly should be adjusted based at least in part on the monitor signal.

24. A system as recited in claim 14 wherein the aperture wall quality monitor is configured to monitor strength of the at least one of the substantially brittle cover items at the vicinity of the corresponding first aperture.

25. A system as recited in claim 14 further comprising a chemical strengthening assembly configured to chemically strengthen the substantially brittle cover items for consumer electronic products.

26. A system as recited in claim 25 further comprising a controller coupled with the chemical strengthening assembly for controlling at least one processing parameter of the chemical strengthening assembly.

27. A system as recited in claim 14 further comprising a controller coupled with the aperture wall quality monitor for receiving a monitor signal that is substantially related to strength of the first aperture wall of the first aperture of at least one of the substantially brittle cover items.

28. A system as recited in claim 14 further comprising a controller,
wherein the controller is coupled with the aperture wall quality monitor for receiving a monitor signal that is substantially related to strength of the first aperture wall of the first aperture of at least one of the substantially brittle cover items, and
wherein the controller is configured to generate an indicator signal when strength of the substantially brittle cover items should be adjusted, based at least in part on the monitor signal.

29. A method for producing substantially brittle cover item for consumer electronic products, the method comprising:
obtaining a substantially brittle cover item for consumer electronic products, the substantially brittle cover item having a first aperture wall of a first aperture extending therethrough;
polishing the first aperture wall of the first aperture of each of the substantially brittle cover items; and
monitoring the polishing of the first aperture wall of the first aperture of the substantially brittle cover item.

30. A method as recited in claim 29, wherein the monitoring of the polishing of the first aperture wall of the first aperture is performed using a load breakage test applied proximate to the first aperture.
